(19) United States
(12) Patent Application Publication
(10) Pub. No.: US 2025/0003101 A1
(43) Pub. Date: Jan. 2, 2025

(54) ROBUST ELECTRODE ARRAYS FOR ELECTROCHEMICAL-ADDITIVE MANUFACTURING SYSTEMS

(71) Applicant: Fabric8Labs, Inc., San Diego, CA (US)

(72) Inventors: Ryan Nicholl, San Diego, CA (US); David Pain, Oceanside, CA (US); Edward White, San Diego, CA (US); Lewis Fowler-Gerace, San Diego, CA (US)

(73) Assignee: Fabric8Labs, Inc., San Diego, CA (US)

(21) Appl. No.: 18/582,350

(22) Filed: Feb. 20, 2024

Related U.S. Application Data
(60) Provisional application No. 63/511,541, filed on Jun. 30, 2023.
(60) Provisional application No. 63/580,411, filed on Sep. 4, 2023.

(51) Int. Cl. C25D 1/00; B33Y 30/00

(52) U.S. Cl. CPC C25D 1/003; B33Y 30/00

(57) ABSTRACT

Described herein are printheads for electrochemical-additive manufacturing (ECAM) comprising extended electrode interconnects and other features for preventing electrolyte ingress and protecting the electrode-interface circuits of these printheads. For example, an electrode interconnect may comprise a metal trace extending in-plane between and interconnecting two vertical (out-of-plane) conductors such that the shortest/direct distance between these vertical conductors is substantially smaller than the length/path of this metal trace. As such, the metal trace substantially increases the electrolyte migration path between these vertical conductors. Furthermore, multiple metal traces (at different levels) may be used with vertical conductors being offset from each other. Finally, electrode edges may protrude into the insulator recesses thereby preventing these edges from peeling and increasing the contact interface between the electrodes and the insulator. Electrode edges may be covered with a protective layer to ensure uniform current density through the exposed electrode surface.

### CROSS-REFERENCE TO RELATED APPLICATIONS

This application claims the benefit under 35 U.S.C. § 119(e) of U.S. Provisional Patent Application No. 63/511,541, filed on 2023 Jun. 30 (Ref. F8L-028-PROV), U.S. Provisional Patent Application No. 63/580,411, filed on 2023 Sep. 4 (Ref. F8L-028-PRO2), all of which are incorporated herein by reference in their entirety for all purposes.

### BACKGROUND

Additive manufacturing, also known as 3-dimensional (3D) printing, is often used to produce complex parts using a layer-by-layer deposition process on substrates. Additive manufacturing can utilize a variety of processes in which various materials (e.g., plastics, liquids, and/or powders) are deposited, joined, and/or solidified. Some examples of techniques used for additive manufacturing include vat photopolymerization, material jetting, binder jetting, powder bed fusion (e.g., using selective laser melting or electron beam melting), material extrusion, directed energy deposition, and sheet lamination. However, metal additive manufacturing has been limited due to the high cost associated with selective laser melting and electron beam melting systems. Furthermore, thermal fusing produces parts with rough surface finishes because the unmelted metal powder is often sintered to the outer edges of the finished product. Electrochemical-additive manufacturing (ECAM) provides many new options not available with conventional additive manufacturing techniques.

### SUMMARY

Described herein are protected electrode arrays comprising extended electrode interconnects and other features for preventing fluid ingress and protecting electrode-interface circuits. Such arrays can be used as printheads for electrochemical-additive manufacturing (ECAM). For example, an electrode interconnect may comprise a metal trace extending in-plane between and interconnecting two vertical (out-of-plane) conductors such that the shortest/direct distance between these vertical conductors is substantially smaller than the length/path of this metal trace. As such, the metal trace substantially increases the electrolyte migration path between these vertical conductors. Furthermore, multiple metal traces (at different levels) may be used with vertical conductors being offset from each other. Finally, electrode edges may protrude into the insulator recesses thereby preventing these edges from peeling and increasing the contact interface between the electrodes and the insulator. Electrode edges may be covered with a protective layer to ensure uniform current density through any exposed electrode surface.

Clause 1. A printhead comprising: an electrode interface circuit comprising a circuit base, an array of deposition control circuits supported by the circuit base, and an array of electrode connectors supported by the circuit base, wherein each deposition control circuit of the array of deposition control circuits is configured to controllably connect a corresponding electrode connector of the array of electrode connectors to a power supply; and an electrode array comprising an array insulator comprising a bottom insulator sublayer, a second insulator sublayer, and a top insulator sublayer, wherein: each element of the electrode array comprises an electrode and an electrode interconnect extending through the array insulator and electrically interconnecting the electrode with one electrode connector of the array of electrode connectors, the electrode interconnect comprises a bottom interlayer conductor, a bottom metal trace, a second interlayer conductor, a second metal trace, and a top insulator sublayer, the bottom interlayer conductor is located at least partially within one via of bottom-insulator-sublayer vias extending through the bottom insulator sublayer, the second interlayer conductor is located at least partially within one via of second-insulator-sublayer vias extending through the second insulator sublayer, the second interlayer conductor is offset relative to the bottom interlayer conductor, does not overlap with the bottom interlayer conductor, and is connected to the bottom interlayer conductor by the bottom metal trace, the top interlayer conductor is located at least partially within one via of top-insulator-sublayer vias extending through the top insulator sublayer, the top interlayer conductor is offset relative to the second interlayer conductor, does not overlap with the second interlayer conductor, and is connected to the second interlayer conductor by the second metal trace, the array insulator comprises an insulator surface facing away from the electrode interface circuit and at least partially defined by an insulator surface plane, and the electrode at least partially extends over the insulator surface.

Clause 2. The printhead of clause 1, wherein: the bottom metal trace, interconnecting and extending between the bottom interlayer conductor and the second interlayer conductor, defines a bottom-metal-trace path, and an overall path length of the bottom-metal-trace path is greater than a direct distance required to directly connect the bottom interlayer conductor and the second interlayer conductor.

Clause 3. The printhead of clause 2, wherein the overall length of the bottom-metal-trace path is at least 3 times greater than the direct distance between the bottom interlayer conductor and the second interlayer conductor.

Clause 4. The printhead of clause 1, wherein the bottom metal trace has a serpentine shape.

Clause 5. The printhead of clause 1, wherein the bottom metal trace has a spiral shape.

Clause 6. The printhead of clause 1, wherein the top interlayer conductor is operable as the electrode.

Clause 7. The printhead of clause 1, wherein the bottom interlayer conductor directly interfaces and is connected to the electrode connectors of an electrode-interface circuit.

Clause 8. The printhead of clause 1, wherein: the second metal trace, interconnecting and extending between the second interlayer conductor and the top interlayer conductor, defines a second-metal-trace path, and an overall path length of the second-metal-trace path is greater than a second direct distance required to directly connect the second interlayer conductor and the electrode.

Clause 9. The printhead of clause 1, further comprises an adhesion layer disposed at least partially between the electrode and the insulator surface.

Clause 10. The printhead of clause 9, wherein the adhesion layer comprises at least one of

silicon nitride (SiNx) and silicon oxide (SiO2).

Clause 11. The printhead of clause 1, wherein: the array insulator comprises an insulator surface facing away from the electrode interface circuit and at least partially defined by an insulator surface plane, the array insulator comprises an insulator via and an insulator recess protruding away from the insulator surface plane and toward, but not extending to, the electrode interface circuit, and a first portion of the electrode protrudes into the insulator via and makes a connection with the electrode interconnect.

Clause 12. The printhead of clause 11, wherein a second portion of the electrode extends away from the insulator via and comprises an electrode edge at least partially within the insulator recess.

Clause 13. The printhead of clause 12, wherein a length of an interface between the insulator surface and the second portion of the electrode is at least 10% greater than a projection of this length to the insulator surface plane.

Clause 14. The printhead of clause 12, wherein a length of an interface between the insulator surface and the second portion of the electrode is at least 30% greater than a projection of this length to the insulator surface plane.

Clause 15. The printhead of clause 12, wherein the insulator via and the insulator recess are separated by a portion of the array insulator extending to the insulator surface plane.

Clause 16. The printhead of clause 12, wherein the first portion of the electrode has an exposed edge positioned below the insulator surface plane.

Clause 17. The printhead of clause 12, further comprising a metal edge protective layer extending over at least a portion of the array insulator and at least a portion of the electrode such that at least a portion of the electrode edge is covered with the metal edge protective layer.

Clause 18. The printhead of clause 17, wherein the metal edge protective layer is formed from an electronically insulating material.

Clause 19. The printhead of clause 18, wherein the metal edge protective layer extends between and overlaps with both the electrode and an adjacent electrode.

Clause 20. The printhead of clause 17, wherein the metal edge protective layer is formed from one or more materials selected from the group consisting of a polyimide (PI), a polybenzoxazole (PBO), a patternable epoxy, and a metal oxide.

Clause 21. The printhead of clause 1, wherein the array insulator comprises a material selected from the group consisting of a polyimide (PI), a polybenzoxazole (PBO), and a patternable epoxy.

Clause 22. The printhead of clause 1, wherein the electrode and the electrode interconnect are separated by an interface layer comprising one or more materials selected from the group consisting of titanium, tantalum, and aluminum.

Clause 23. The printhead of clause 1, wherein the electrode comprises one or more materials selected from the group consisting of PtIr, PtRu, PtRh, Ta, Nb, and SiB.

Clause 24. The printhead of clause 1, wherein a surface area of the electrode is greater than 5 times larger than a surface area of the via in which the third is located at least partially within.

### BRIEF DESCRIPTION OF THE DRAWINGS

FIG. 1A is a schematic illustration of an ECAM system comprising a printhead, in accordance with some examples.

FIG. 1B is a schematic illustration of an electrochemical cell of the ECAM system, the cell comprising a printhead and a deposition electrode, in accordance with some examples.

FIG. 1C is a schematic planar view of a printhead comprising electrodes, in accordance with some examples.

FIG. 2 is a schematic cross-sectional view of an ECAM system illustrating the electrolytic deposition of material from the electrolyte solution onto a deposition electrode, in accordance with some examples.

FIG. 3 is a block diagram illustrating various components of an electrolytic solution used for electrolytic deposition, in accordance with some examples.

FIGS. 3A-3C are schematic cross-sectional views of a printhead subassembly at various stages during the printhead fabrication, in accordance with some examples.

FIGS. 4 and 5 are schematic expanded views of two examples of a metal trace used in a printhead.

FIGS. 6A-6C are schematic cross-sectional views of additional stages during the printhead fabrication, in accordance with some examples.

FIG. 7A is a schematic cross-sectional view of a printhead comprising electrodes connected to the electrode-interface circuit by electrode interconnects, in accordance with some examples.

FIG. 7B is an example of an electrode supported within an array insulator.

FIG. 7C is another example of an electrode supported within an array insulator with the electrode edge extending over the insulator surface.

FIGS. 8A and 8B are two examples of electrodes supported within an array insulator such that the electrode edges extend into insulator recesses for enhanced bonding between the electrode and the array insulator.

FIG. 9A is a schematic cross-sectional view of an electrode interconnect, in accordance with some examples.

FIGS. 9B-9G are schematic planar views of the first and second metal traces for an electrode interconnect, in accordance with some examples.

FIG. 10 is a schematic cross-sectional view of an electrode supported within an array insulator with the electrode edge covered with the metal edge protective layer, in accordance with some examples.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

### Introduction

Protected electrode arrays have many applications, including as biological sensors, biological stimulators, electrochemical additive manufacturing (ECAM) printheads, etc. ECAM systems use electrolytic solutions/electrolytes to form parts having various shapes, compositions, and other characteristics. An example ECAM system comprises two electrodes, one of which is arranged into an electrode array to provide more granular control over deposition conditions. Specifically, the electrode array is formed by electrodes, which can be arranged as a two-dimensional (2D) grid, and which can be also referred to as electrode pixels or pixelated electrodes. When these electrodes are used as positive electrodes for supplying positive electrical charge to and receiving electrons from the electrolyte, these electrodes can be referred to as pixelated anodes. The electrode array may be also referred to as a printhead, providing a reference to 3D printing aspects of ECAM systems. Furthermore, display terminology can be used to refer to electrodes as “pixels”. An instantaneous activation pattern produced by the array (by controllably activating a subset of pixels) may be referred to as an “image”. Another electrode of an ECAM system can be referred to as a deposition electrode or, more specifically, an electrolytic-deposit-receiving electrode. This electrode is configured to receive electrolytically deposited material during system operation.

The operation of electrode connectors or, more generally, electrodes can be controlled using control circuits, e.g., thin-film transistors (silicon-based thin-film transistors, indium-gallium-zinc oxide-based transistors, etc.) in which case, the array can be referred to as a thin-film transistor (TFT) array or a TFT micro-electrode array. These electrodes and corresponding deposition control circuits can be arranged in various patterns, e.g., 2-D rectangular, 2-D hexagonal, and other like patterns. Furthermore, these electrodes may be of uniform or non-uniform size, shape, thickness, composition, and other characteristics.

Specifically, the current density distribution is a critical parameter of the ECAM process. The current density distribution is influenced by the electrolyte conductivity, electrode shapes/positions relative to each other, electrode surface properties (e.g., the presence and properties of surface-active molecules), and potentials applied (which is one of the distinguishing features of the ECAM systems), among other factors. One advantage of using electrode arrays is controlling the current density distribution at each electrode. When an electrolytic-deposit-receiving electrode is positioned sufficiently close to an electrode array, this current density distribution at each electrode is translated into the corresponding current density distribution on the portions of the deposition electrode aligned with the corresponding electrodes. This corresponding current density distribution can be used for controlling plating rates, grain structures, grain sizes, and deposits' compositions among other characteristics. Overall, this current density control can be used to fabricate 3D parts (“prints”) by successive controlled deposition of layers based on the desired properties of the product.

The electrode array and the electrolytic-deposit-receiving electrode are often positioned close together, e.g., less than 100 micrometers from each other, forming a gap. This arrangement helps to control the selective deposition aspects provided by each electrode. Specifically, each electrode is aligned with a specific portion of the deposition electrode surface or, even more specifically, with a specific portion of the deposited material surface. For purposes of this disclosure, the terms “deposited material” and “deposition electrode” are often used interchangeably since the deposition is performed on the deposited material surface using the electric current passing through both the deposition electrode and the deposited material. The deposited material effectively becomes part of the deposition electrode/cathode during the deposition operation. It should be noted that controlling the operation of this electrode effectively controls the deposition on the corresponding surface portion, aligned with the electrode.

In some application examples, electrode arrays can operate in various electrolyte environments, some of which can be damaging to these arrays. For example, electrode arrays and deposition control circuits, positioned under these arrays can corrode after prolonged operations in such electrolyte environments. Furthermore, various substrates used for supporting these electrodes and circuits can be damaged. This damage and the overall degradation can be further exacerbated by electric currents flowing through electrodes during their operation.

Some examples of bonding include, but are not limited to (a) adhesive bonding via benzo-cyclobutene (BCB), polyimide (PI), epoxy-based photoresists such as SU-8, PermiNex®, etc.—may require high temperature and chemical resistance; (b) bump bonding—may require additional processing steps, high risk; (c) eutectic-for specific material compatibilities; (d) Au—Au thermo-compression-possibly additional processing steps, generally high alignment/resolution requirement, may introduce the risk of shorting; (e) anodic materials/compatibility and high flatness; (f) silicon fusion-may require high temperature; and (g) glass frit-may require high temperature, may be hard to pattern.

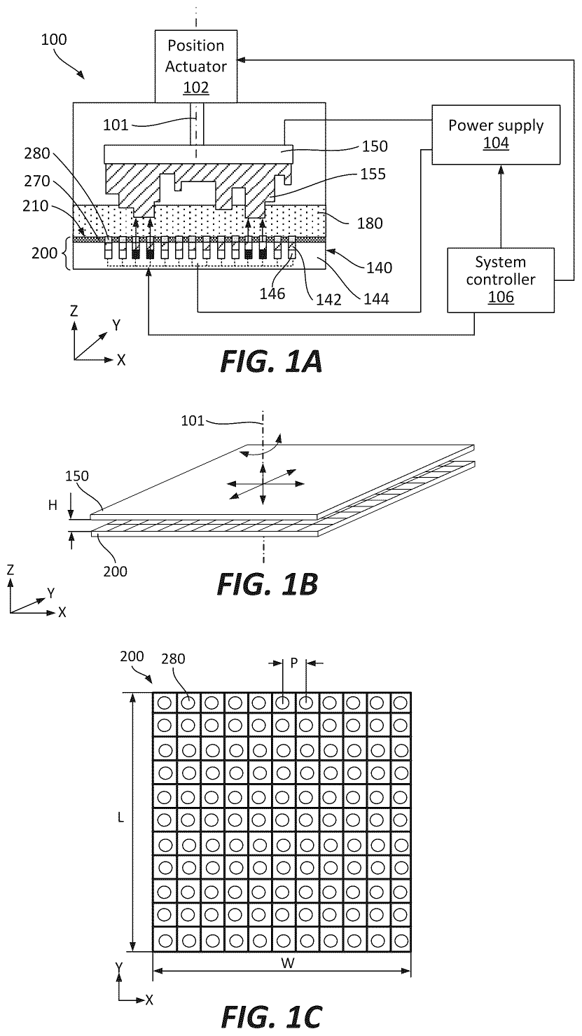

### FIGS. 1A-1C, 2, and 3: ECAM System Examples

Protected electrode array assemblies can be used, as printheads, for various applications and systems, e.g., ECAM system 100. FIG. 1A is a schematic illustration of ECAM system 100 used for depositing or, more specifically, electroplating material 155, in accordance with some examples. ECAM system 100 may comprise a position actuator 102, a system controller 106, a deposition power supply 104, a printhead 200, and a deposition electrode 150. In some examples, deposition electrode 150 is connected to deposition power supply 104 and controllably supported relative to the printhead 200 (e.g., by position actuator 102).

Printhead 200 comprises electrode-interface circuit 140, which may comprise circuit base 144 as well as electrode connectors 142 and deposition control circuits 146, both supported by circuit base 144. Each deposition control circuit 146 controls the current flow through a corresponding one of electrode connectors 142 (e.g., based on input from the system controller 106) and eventually through the corresponding electrodes 280 as well the corresponding portion of the electrolyte solution 180 thereby causing the deposition on the corresponding surface of material 155 on deposition electrode 150.

Position actuator 102 can be mechanically coupled to electrode-interface circuit 140 and/or deposition electrode 150 and used to change the relative position of electrode-interface circuit 140 and deposition electrode 150 (e.g., changing the gap between electrode-interface circuit 140 and deposition electrode 150, linearly moving and/or rotating one or both electrode-interface circuit 140 and deposition electrode 150 within a plane parallel to the electrode-interface circuit 140). While FIG. 1A illustrates position actuator 102 being coupled to deposition electrode 150, other examples are also within the scope.

System controller 106 is used for controlling the operations of various components. For example, FIG. 1A illustrates system controller 106 being communicatively coupled with position actuator 102, deposition power supply 104, and deposition control circuits 146. For example, the system controller 106 can instruct position actuator 102 to change the relative position of electrode-interface circuit 140 and deposition electrode 150. In the same or other examples, the system controller 106 can selectively instruct some deposition control circuits 146 to provide current through corresponding electrode connectors 142.

During the operation of ECAM system 100, system 100 also comprises electrolyte solution 180 comprising a source of cations (e.g., metal cations) that are reduced on deposition electrode 150 (operable as a cathode during this operation) and form material 155. More specifically, material 155 is deposited onto deposition electrode 150 from electrolyte solution 180 by flowing the electrical current between selected ones of electrode connectors 142 and deposition electrode 150 as noted above. In some examples, further granularity is provided by controlling the current levels through each electrode connector 142. In other words, not only the current can be shut off through one or more electrode connectors 142 but different levels of current can flow through different electrode connectors 142.

FIG. 1B is a perspective schematic view of a printhead 200 and deposition electrode 150, in accordance with some examples. This combination of printhead 200 and deposition electrode 150 may be also referred to as an electrodeposition cell, which is a primary component of ECAM system 100. Deposition electrode 150 and printhead 200 form a gap, which is filled (partially or fully) with an electrolyte solution during the operation. The height (H) of this gap is specifically controlled (e.g., between 5 micrometers and 200 micrometers) as the height influences the deposition conditions. For example, an excessive gap height can result in lower deposition rates and less control over the deposition locations. On the other hand, a gap height below the target value can cause excessive deposition rates and even shorts. It should be noted that the height gap can be different at different portions of deposition electrode 150 and printhead 200. Furthermore, the average gap height can change between various deposition and electrolyte flow stages (e.g., using position actuator 102). For example, the average gap height can be increased to decrease the average current flow between deposition electrode 150 and printhead 200 (and vice versa). Furthermore, the gap can be increased (while the deposition is suspended) to flow fresh electrolyte solution into the gap. Overall, deposition electrode 150 and printhead 200 can be moved relative to each in various directions as indicated in FIG. 1B, e.g., along primary axis 101 and/or within the plane perpendicular to primary axis 101 (including the rotation about primary axis 101).

Referring to FIG. 1C, printhead 200 comprises electrodes 280, which may be also referred to as microelectrodes (or micro-anodes), and/or pixels. More specifically, ECAM system 100 provides electrical control of each electrode 280 (using separate deposition control circuits 146). This individually-addressable feature of these electrodes 280 allows the achievement of different deposition rates at different locations on deposition electrode 150. Electrodes 280 form a deposition grid, in which these electrodes may be offset relative to each other along the X-axis and Y-axis, each within a grid footprint. Rectangular grids may be characterized by a grid X-axis pitch (corresponding to the length of each grid region along the X-axis), grid Y-axis pitch (corresponding to the length of a grid region along the Y-axis), overall grid pitch (corresponding to the minimum of the grid X-axis pitch and the grid Y-axis pitch), and grid region area. In the same or other examples, one or both of the grid's X-axis pitch and the Y-axis pitch are 100 micrometers or less, 50 micrometers or less, or even 35 micrometers or less. Other example grids include triangular, hexagonal, or other patterns that partially or completely tessellate a surface. In some examples, electrodes 280 are formed/deposited from an insoluble conductive material, such as platinum group metals and their associated oxides, doped semiconducting materials, and carbon nanotubes. The shape of the electrodes 280 can be round, rectangular, or other shapes. The area of the electrodes 280 (the pixel size) is smaller (e.g., at least 1% smaller, at least 10% smaller, at least 20% smaller) than the grid footprint, thereby providing space between the electrodes 280. In some examples, the pitch is between 25 micrometers and 35 micrometers, while the pixel size is between 15 micrometers and 20 micrometers.

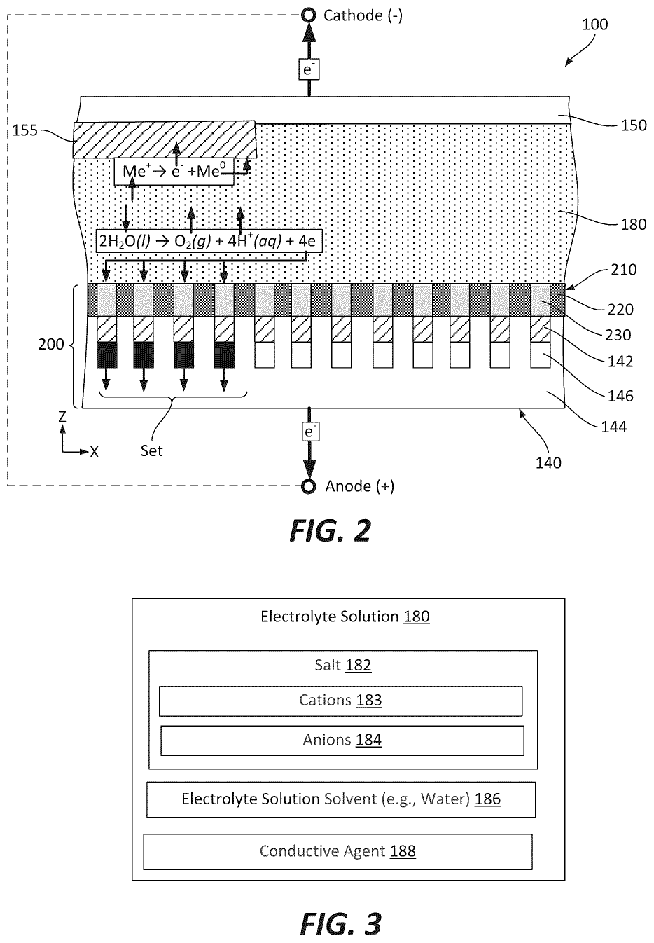

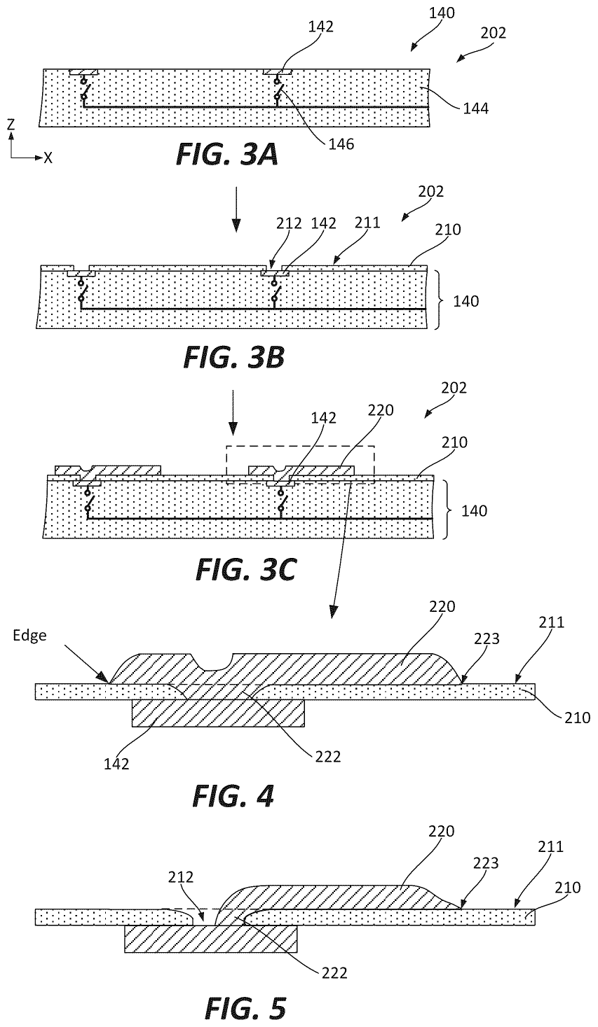

FIG. 2 is a schematic expanded view of a portion of ECAM system 100 illustrating electrolyte solution 180 between printhead 200 (which may be referred to as a printhead) and deposition electrode 150, in accordance with some examples. FIG. 3 is a schematic block diagram illustrating different components of electrolyte solution 180. For example, electrolyte solution 180 may comprise salt 182, electrolyte solution solvent 186, and conductive agent 188. Salt comprises cations 183 and anions 184. Cations 183 can be in the form of metal ions, metal complexes, and the like. Some examples of cations 183 include metal cations (e.g., copper ions, nickel ions, tungsten ions, gold ions, silver ions, cobalt ions, chrome ions, iron ions, or tin ions), and other types of cations are within the scope. Some specific examples of salt 182 (feedstock ion sources) include but are not limited to copper sulfate, copper chloride, copper fluoroborate, copper pyrophosphate, nickel sulfate, nickel ammonium sulfate, nickel chloride, nickel fluoroborate, zinc sulfate, sodium thiocyanate, zinc chloride, ammonium chloride, sodium tungstate, cobalt chloride, cobalt sulfate, hydroxy acids, and aqua ammonia. In some examples, feedstock ion sources, or other sources of cations (e.g., salts) are referred to as material concentrates. Electrolyte solution solvent 186 can be water, which dissociates (2H₂O(I)=>O₂(g)+4H⁺(aq.)+4e⁻) on electrode-interface circuit 140 or, more specifically, on electrode connectors 142 that are activated during this operation. Specifically, the activated electrode connectors 142 are connected to deposition power supply 104 (by the corresponding deposition control circuits 146). In some examples, electrolyte solution 180 comprises catholyte conductive agent 188, such as an acid (e.g., sulfuric acid, acetic acid, hydrochloric acid, nitric acid, hydrofluoric acid, boric acid, citric acid, and phosphoric acid). In some examples, electrolyte solution 180 comprises one or more additives, such as a leveler, a suppressor, and an accelerator, particulates for co-deposition (e.g., nanoparticles and microparticles such that diamond particles, tungsten-carbide particles, chromium-carbide particles, and silicon-carbide particles).

In some examples, electrolyte solution 180 is provided in an electrolyte-carrying structure, e.g., sponge, porous film, mesh, and the like. The electrolyte-carrying structure can be advanced (e.g., can be rewound) between electrode-interface circuit 140 and deposition electrode 150 as electrolyte solution 180 is consumed. In some examples, electrode-interface circuit 140 and deposition electrode 150 are advanced toward each other to displace (squeeze) electrolyte solution 180 from the electrolyte-carrying structure.

Returning to the example shown in FIG. 2, cations (e.g., metal cations are combined with electrons, which are supplied to deposition electrode 150 thereby forming material 155 (e.g., metal deposit—Me⁰). As noted above, the charge balance within electrolyte solution 180 is maintained by protons generated at printhead 200. It should be noted that only a set of electrodes 280 (corresponding to the activated deposition control circuits 146, illustrated in black color) can be activated during this ECAM process resulting in electrolytic deposit/material 155 formed on a corresponding portion of deposition electrode 150. This corresponding portion is aligned with the activated electrode 280 while the remaining portion of deposition electrode 150 remains free of electrolytic deposit. This selective deposition is a core ECAM feature provided by selective control of the current passing through the activated electrodes 280.

### FIGS. 3A-3C, 4, 5, and 6A-6C: Printhead Examples

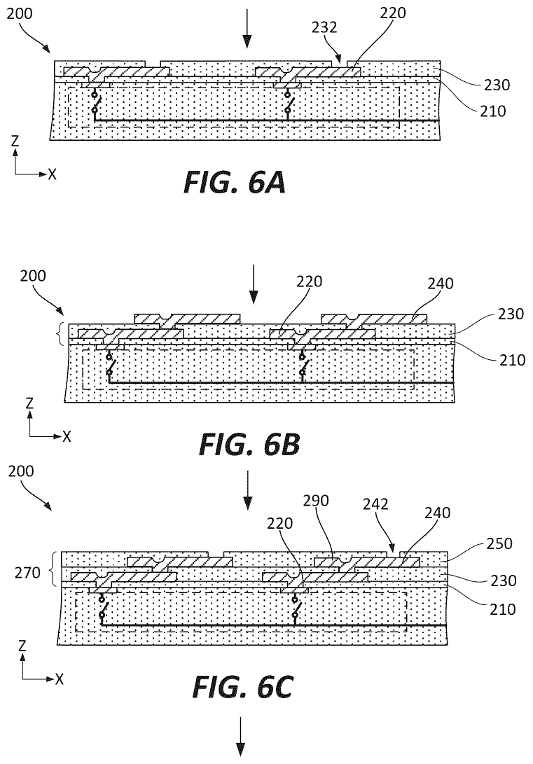

FIGS. 3A-3C are schematic cross-sectional views of a printhead subassembly 202 at various stages during the printhead fabrication, in accordance with some examples. Specifically, FIG. 3A illustrates an electrode-interface circuit 140 comprising a circuit base 144 and electrode connectors 142, positioned in and supported within the circuit base 144. The electrode-interface circuit 140 also comprises deposition control circuits 146, each configured to controllably connect a corresponding one of the electrode connectors 142 to a power supply. Various other components of the printhead subassembly 202 are either formed over the electrode-interface circuit 140 (e.g., as shown in FIGS. 3A-3C and FIGS. 6A-6C) or formed as separate assemblies and then attached to the electrode-interface circuit 140. Specifically, FIG. 3B illustrates the first insulator sublayer 210 formed on the electrode-interface circuit 140. The first insulator sublayer 210 may be also referred to as a bottom insulator sublayer due to its location in the overall stack. The first insulator sublayer 210 has first-insulator-sublayer vias 212, exposing the electrode connectors 142. The first insulator sublayer 210 also comprises a first-insulator-sublayer surface 211 used to receive other components of the printhead subassembly 202. FIG. 3B illustrates a first metal trace 220 deposited over the first insulator sublayer 210 such that a portion of the first metal trace 220 extends into the first-insulator-sublayer vias 212 and interfaces with/connects to the electrode connectors 142. The first metal trace 220 may be referred to as a bottom metal trace. Another portion of the first metal trace 220 extends over the first-insulator-sublayer surface 211. This extension helps to align/connect additional metal layers, later provided over the first metal trace 220 (as further described below with reference to FIGS. 6A-6C).

FIGS. 4 and 5 are schematic expanded views of two examples of a metal trace used in a printhead or, more specifically, the first metal trace 220 in the printhead subassembly 202 shown in FIG. 3B. In FIG. 4, the first-insulator-sublayer vias 212 is completely filled with the first metal trace 220, which extends over the first-insulator-sublayer surface 211 on both sides of the first-insulator-sublayer vias 212. It should be noted that the first-metal-trace edge 223 is positioned on the first-insulator-sublayer surface 211. In FIG. 5, the first metal trace 220 does not completely fill the first-insulator-sublayer via 212 and extends over the first-insulator-sublayer surface 211 only on one side of the first-insulator-sublayer vias 212 (e.g., to the right of the first-insulator-sublayer vias 212 as shown in FIG. 5). Similar to FIG. 4, the first-metal-trace edge 223 is positioned on the first-insulator-sublayer surface 211. There are many reasons why a metal trace 220 may not completely fill via 212, including inadvertent (alignment issues, etc.) and intentional (leaving a gap for later deposition of insulating and/or conductive material, etc.). Other configurations are possible, for example, metal trace 220 may completely fill via 212 but extend over the first-insulator-sublayer surface 211 only on one side of the via.

FIGS. 6A-6C are schematic cross-sectional views of additional stages during the printhead fabrication, in accordance with some examples. Specifically, in FIG. 6A, a second insulator sublayer 230 is formed over the first insulator sublayer 210 and the first metal traces 220. The second insulator sublayer 230 has second-insulator-sublayer vias 232, which do not have to align with the first-insulator-sublayer vias 212 due to the extension of the first metal trace 220. In FIG. 6B, second metal traces 240 are formed over the second insulator sublayer 230 and the first metal traces 220. Finally, in FIG. 6C, a third insulator sublayer 250 is formed over the second insulator sublayer 230 and the second metal traces 240. A combination of the first insulator sublayer 210, the second insulator sublayer 230, and the third insulator sublayer 250 (as well as any other insulator layers, if present) may be referred to as an array insulator 270. In some examples, the array insulator 270 comprises one or more materials selected from the group consisting of a polyimide (PI), a polybenzoxazole (PBO), a patternable epoxy, and the like. A combination of the first metal trace 220 and second metal trace 240 (as well as any other metal traces, if present) may be referred to as an electrode interconnect 290. Overall, each element of the electrode array 204 comprises an electrode 280 and an electrode interconnect 290 extending through the array insulator 270 and electrically interconnecting the electrode 280 with one electrode connector 142 of the array of electrode connectors.

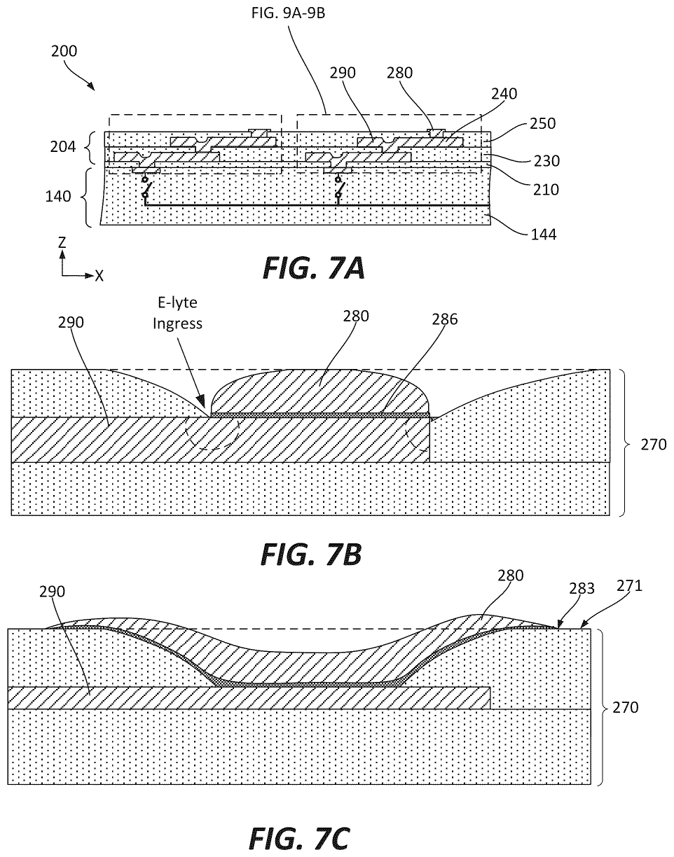

### FIGS. 7A-7C: Examples of Protected Electrode Array Assemblies

Referring to FIG. 7A, in some examples, a printhead 200 comprises an electrode-interface circuit 140 and an electrode array 204 stacked over the electrode-interface circuit 140 such that the electrode array 204 protects the electrode-interface circuit 140 from the environment (e.g., the electrolyte). The electrode interface circuit 140 comprises a circuit base 144, deposition control circuits 146 supported by the circuit base 144, and electrode connectors 142 supported by the circuit base 144. Each of the deposition control circuits 146 is configured to controllably connect a corresponding one of the electrode connectors 142 to a power supply. The electrode array 204 comprises an array insulator 270, an electrode 280, and an electrode interconnect 290 extending through the array insulator 270 and electrically interconnecting the electrode 280 with one of the electrode connectors 142. Example processes of forming the array insulator 270 and electrically interconnecting the electrode 280 are described above.

FIGS. 7B and 7C are two examples of electrodes 280 supported within an array insulator 270. Specifically, the electrodes 280 can be formed from platinum or other conductive materials suitable for the operating environment of the printhead 200. In more specific examples, the electrode 280 comprises one or more materials selected from the group consisting of PtIr, PtRu, PtRh, Ta, Nb, and SiB. In some examples, the printhead 200 comprises interface layer 286, positioned between the electrode 280 and the electrode interconnect 290. For example, the interface layer 286 can be formed (e.g., sputtered) from one or more of titanium, tantalum, aluminum, and the like. The electrode interconnect 290 can also be formed using such typical semiconductor manufacturing methods and others, etc. FIG. 7B illustrates that the via in the top insulator sublayer, which is also identified as a third insulator sublayer 250, is not completely filled with the electrode 280, such that potential ingress points may exist allowing electrolyte solutions to reach the electrode interconnect 290. FIG. 7C illustrates an example in which the electrode edge 283 is positioned over the insulator surface 271 of the array insulator 270. In some examples, the surface area of the electrode 280 may be a multiple (1.5, 2, 5, 10, etc.) of the surface area of the via hole. In some examples, the electrode edge 283 on the insulator surface 271 potentially allows delamination of the electrode edge 283 from the insulator surface 271. In some examples, an adhesion layer of a material such as SiNx, SiO2, etc. is positioned between a photo-patternable insulating material (acrylic, polyimide, PBO, etc.) and a metal electrode layer. This layer may serve to help prevent the metal layers from delaminating from the insulating material. In some examples, the adhesion layer is patterned to cover the upper insulating layer while leaving at least some of the electrode interconnect 290 uncovered.

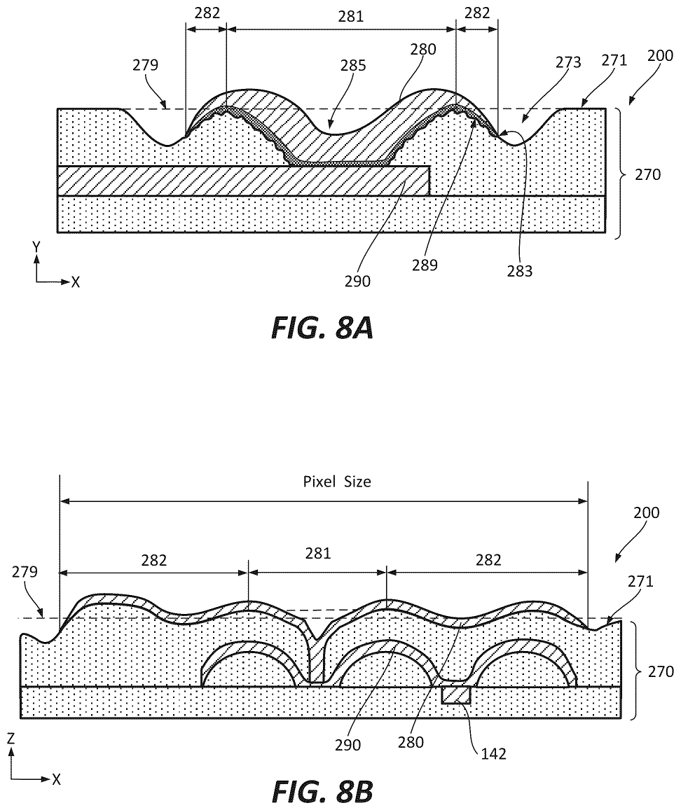

### FIGS. 8A-8B-Examples of Electrode Edges Extending into Insulator Recesses

Referring to FIG. 8A, in some examples, the array insulator 270 comprises an insulator surface 271 facing away from the electrode interface circuit 140 and at least partially defined by an insulator surface plane 279. It should be noted that portions of the insulator surface 271 can deviate from the insulator surface plane 279. For purposes of this disclosure, the insulator surface plane 279 is defined as a plane that is most proximate to the insulator surface 271. A portion of the insulator surface 271 is covered by electrodes 280. The remaining portion can be exposed to the environment (e.g., the electrolyte).

The array insulator 270 comprises an insulator via 272 and an insulator recess 273 protruding away from the insulator surface plane 279 and toward, but not extending to, the electrode interface circuit 140. Specifically, the insulator via 272 is a through opening/hole that extends to the electrode interconnect 290. As such, the first portion 281 of the electrode 280 protrudes into the insulator via 272 and makes a connection (mechanical and electrical) with the electrode interconnect 290. A second portion 282 of electrode 280 extends away from the insulator via 272 and comprises an electrode edge 283, and protrudes into the insulator recess 273, e.g., as shown in FIG. 8A. This feature (of the electrode edge 283 protruding into the insulator recess 273) helps to reduce the edge peeling risk described above with reference to FIG. 7C.

Referring to FIG. 8A, in some examples, the insulator via 272 and the insulator recess 273 are separated by a portion of the array insulator 270 extending to the insulator surface plane 279. As such, the second portion 282 extends over the insulator surface plane 279. In some examples, the first portion 281 of the electrode 280 has an exposed surface positioned below the insulator surface plane 279. In other words, the first portion 281 of the electrode 280 has an electrode recess 285. These non-planar aspects of the electrode may have several advantages, including providing better adherence to the insulator due to a greater contact area, per volume of electrode metal and/or per the same grid footprint.

Overall, the first portion 281 of the electrode 280 protrudes into the insulator via 272 and makes a connection with the electrode interconnect 290, while the second portion 282 of the electrode 280 extends away from the insulator via 272 and comprises an electrode edge 283 that protrudes into the insulator recess 273. In some examples, the length of the interface 289 between the insulator surface 271 and the second portion 282 of the electrode 280 is at least 10% greater than the projection of this length of the interface 289 to the insulator surface plane 279 or, at least 30% greater, or even at least 50% greater. This ratio of the actual length to the projection indicates the curvature of the interface 289 with the greater curvature providing the longer electrolyte ingress path length as well as better grip/adhesion between the second portion 282 of the electrode 280 and the insulator surface 271.

Referring to FIGS. 8A-8B, in some examples, the insulator via 272 and the insulator recess 273 are separated by a portion of the array insulator 270 extending to (and even past) the insulator surface plane 279. FIG. 8B illustrates an example where multiple parts (aka “humps”) of the array insulator 270 extend to/past the insulator surface plane 279. The portion of the array insulator 270, surrounding the via and positioned between the two such adjacent “humps” (one on each side of the via) can be referred to as a first portion 281, while the portions of the array insulator 270 extending past these “humps” can be referred to as a second portion 282. Referring to FIG. 8B, in some examples, the electrode 280 extends over multiple “humps” on each side of the via. Similar to the curvature of the insulator surface 271, a larger interface between the electrode 280 and the insulator surface 271 provides the longer electrolyte ingress path length as well as better grip/adhesion between the second portion 282 of the electrode 280 and the insulator surface 271.

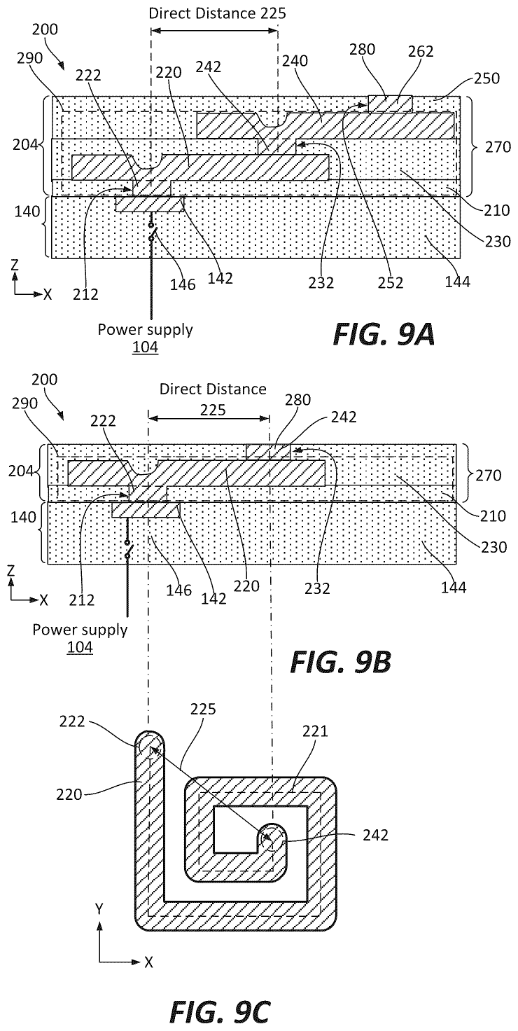

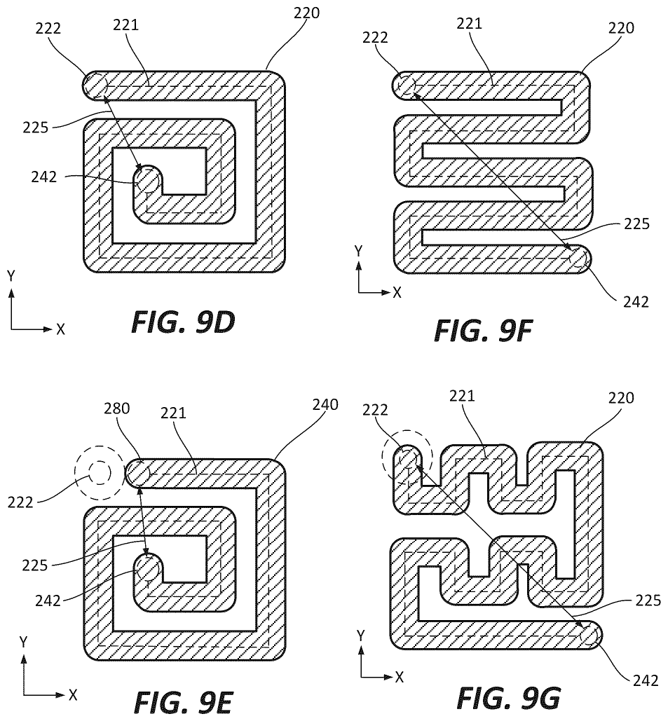

### FIGS. 9A-9G-Examples of Metal Traces Forming Extended Paths Between Conductors

Regardless of the design of the printhead electrodes, there may still be an opportunity for electrolytes to ingress into the printhead, such as the ingress illustrated in FIG. 7B. In some cases, printheads may be made more robust if the length of a path along metal traces connecting the exposed electrode surface to the underlying circuitry is increased. This path length may be extended in some examples by adding multiple layers of thick insulators and metal traces. In addition to the additional vertical distance provided by the thickness of the insulators, the horizontal distance can also be increased on each layer by taking an indirect trace path from the inlet (“IN”) interlayer conductor (via) from a lower layer to the outlet (“OUT”) via to an upper layer (or the electrode). In many examples, vias on different layers are offset from each other (“staggered”) by keeping them away from exclusion areas around existing vias. When surface electrodes are offset from electrode-interface circuit 140 vias through interconnecting metal traces, this offset may also serve to reduce the stress transferred from the electrode surface to the electrode-interface circuit 140 (e.g. in the case of contact between a printhead and a part being fabricated).

Referring to FIGS. 9A-9C and, more specifically, referring to FIG. 9A, in some examples, the electrode interconnect 290 comprises a first interlayer conductor 222, a first metal trace 220, and a second interlayer conductor 242. The first interlayer conductor 222 is located at least partially within one via of first-insulator-sublayer vias 212 extending through the first insulator sublayer 210. The first interlayer conductor 222 may be referred to as a bottom interlayer conductor. The second interlayer conductor 242 is located at least partially within one via of second-insulator-sublayer vias 232 extending through second insulator sublayer 230.

Referring to FIG. 9C, in some examples, the first metal trace 220 is connected to and extends between the first interlayer conductor 222 and the second interlayer conductor 242 defining a first-metal-trace nonlinear path 221. The overall path length of the first-metal-trace path 221 is greater than the direct distance 225 required to directly connect the first interlayer conductor 222 and the second interlayer conductor 242. The first-metal-trace path 221 may be referred to as a bottom-metal-trace path. For purposes of this disclosure, the overall path length (L) of the first-metal-trace path 221 is defined as a combined length of all components and/or segments of the first interlayer conductor 222 corresponding to a “conductor length”, i.e., the length/path that the current travels between the first interlayer conductor 222 and the second interlayer conductor 242 and defining the resistance of the first interlayer conductor 222 (i.e., R=ρ*L/A). Furthermore, for purposes of this disclosure, the direct distance 225 (D) is the shortest distance between the first interlayer conductor 222 and the second interlayer conductor 242 that only depends on the relative positions of the first interlayer conductor 222 and the second interlayer conductor 242 and does not depend on the shape/design of the first interlayer conductor 222.

In some examples, the overall length of the first-metal-trace path 221 is at least 3 times greater than the direct distance 225 between the first interlayer conductor 222 and the second interlayer conductor 242 or even at least 10 times greater. Increasing the overall length of the first-metal-trace path 221 reduced the risk of electrolytes from reaching the first interlayer conductor 222. It should be noted that electrode 280 operates in direct contact with the electrolyte (e.g., submerged into the electrolyte).

FIG. 9A illustrates an example where the array insulator 270 is formed by a first insulator sublayer 210, a second insulator sublayer 230, and a third insulator sublayer 250, with the third insulator sublayer 250 being the top sublayer exposed to the electrolyte. In this example, the electrode 280 protrudes through one of third-insulator-sublayer vias 252 in the third insulator sublayer 250. Alternatively, additional insulator sublayer or multiple insulator sublayers may be positioned over the third insulator sublayer 250, such that interlayer conductors protruding through third-insulator-sublayer vias 252 are not operable as electrodes (but used to connect to additional metal traces, e.g., a third metal trace). In general, an interlayer conductor protruding through one of third-insulator-sublayer vias 252 may be referred to as a third interlayer conductor 262 or a top interlayer conductor (in an example where no additional interlayer conductors are stacked over the third interlayer conductor 262). When the third insulator sublayer 250 is the top-most layer, the third interlayer conductor 262 is operable as an electrode 280, while other examples of electrode 280 are possible, such as those disclosed elsewhere.

Various shapes of the first metal trace 220 can be used to increase the overall length of the first-metal-trace path 221 (relative to the direct distance 225 between the first interlayer conductor 222 and the second interlayer conductor 242). For example, the first metal trace 220 may have a serpentine shape, a spiral shape, and other shapes, e.g., shown in FIGS. 9C-9G.

Referring to FIG. 9B, in some examples, the second interlayer conductor 242 is operable as the electrode 280. In other words, the first metal trace 220 is the top conductive layer. Alternatively, referring to FIG. 9C, the first interlayer conductor 222 directly interfaces and is connected to the electrode connectors 142 of the electrode-interface circuit 140. In other words, the first metal trace 220 is the bottom conductive layer. For example, the array insulator 270 further comprises a third insulator sublayer 250. The electrode interconnect 290 comprises a second metal trace 240. The electrode 280 is located at least partially within one via of third-insulator-sublayer vias 252 extending through the third insulator sublayer 250. The second metal trace 240 is connected to and extends between the second interlayer conductor 242 and the electrode 280 defining a second-metal-trace path. The overall path length of the second-metal-trace path is greater than a second direct distance 225 required to directly connect the second interlayer conductor 242 and the electrode 280.

Referring to FIGS. 9A and 9B, in some examples, the second interlayer conductor 242 is offset relative to the first interlayer conductor 222 and does not overlap with the first interlayer conductor 222, and is connected to the first interlayer conductor 222 by the first metal trace 220. This offset may be within the X-Y plane (with the X-offset shown in FIGS. 9A and 9B), e.g., the plane parallel to the interface between the first insulator sublayer 210 and the second insulator sublayer 230. The offset and non-overlap prevent the electrolyte migration from the second-insulator-sublayer vias 232 to the first-insulator-sublayer vias 212. Even though these vias are filled with the corresponding interlayer conductors, potential gaps between the via walls and the interlayer conductors may be present. The offset and non-overlap may force the electrolyte to travel along the X-Y plane (the path of the first metal trace 220) where such gaps may be a lot less prevalent.

Referring to FIG. 9B, in some examples, the third interlayer conductor 262 is located at least partially within one via of third insulator sublayer 250 vias extending through the second insulator sublayer 250. The third interlayer conductor 262 may be offset relative to the second interlayer conductor 242, does not overlap with the second interlayer conductor 242, and is connected to the second interlayer conductor 242 by the second metal trace 240. The reasons for this offset and non-overlap are the same as explained above. In some examples, the offset between the second interlayer conductor 242 and the first interlayer conductor 222 may be the same as the offset between the third interlayer conductor 262 and the second interlayer conductor 242. Alternatively, the offset between the second interlayer conductor 242 and the first interlayer conductor 222 may be different from the offset between the third interlayer conductor 262 and the second interlayer conductor 242. For example, the offset between the second interlayer conductor 242 and the first interlayer conductor 222 may be less than the offset between the third interlayer conductor 262 and the second interlayer conductor 242.

Referring to FIGS. 9D and 9E, in some examples, a metal trace 220 on a lower layer (FIG. 9D), may be connected to a metal trace on a higher layer (FIG. 9E). Here, the path 221 of the metal trace 220 of the upper layer (9E) follows a similar path to that of path 225 of the lower layer (FIG. 9D) except that an exclusion area around the via for the lower layer interlayer conductor 222 in the layer of FIG. 9D is avoided in the path 221 of FIG. 9E.

FIG. 9F shows one example of a simple serpentine curve, while FIG. 9G shows an example of a space-filling curve that fills as much of the area as possible given the constraints of trace routing.

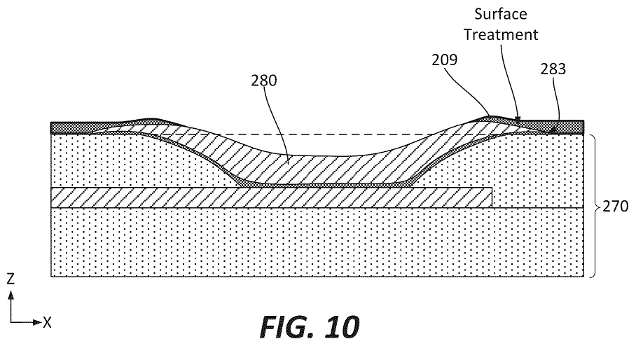

### FIG. 10—Examples of Metal Edge Protective Layers

Referring back to FIG. 7C, the metal edges of some electrodes may be significantly thinner than the centers. In some cases, this may lead to an unequal current density profile over the surface of the electrode during electrodeposition. As mentioned before, the mechanical properties and durability of such an electrode may also be less than ideal. For example, an exposed electrode edge can act as a focal point for mechanical stress and subsequent degradation of the device. In some examples, a surface treatment may be applied to create a metal edge protective layer to address such issues.

Referring to FIG. 10, in some examples, the printhead 200 further comprises a metal edge protective layer 209 extending over the array insulator 270 and at least a portion of the electrode 280 such that the electrode edge 283 is covered with the metal edge protective layer 209. The metal edge protective layer 209 can be formed from various organic and/or inorganic materials, such as SiNx, epoxies like PBO, polyimide, metals (for example, Ti). For metals, example processing steps include: 1) Photolithography, metal deposition, and chemical lift off or 2) metal deposition, photolithography, and wet/dry etching. In some cases, metal edge protective layers may oxidize to provide an electrical insulating property, while oxidation of the electrode itself may result in a monolayer of oxide that still allows deposition current to pass through. Controlling the extent of the coverage of the electrode 280 by the surface treatment allows for shaping the current density produced by the device, which can influence the electroplated geometry of the deposited material.

1. A printhead comprising:
an electrode interface circuit comprising a circuit base, an array of deposition control circuits supported by the circuit base, and an array of electrode connectors supported by the circuit base, wherein each deposition control circuit of the array of deposition control circuits is configured to controllably connect a corresponding electrode connector of the array of electrode connectors to a power supply; and
an electrode array comprising an array insulator comprising a bottom insulator sublayer, a second insulator sublayer, and a top insulator sublayer, wherein:
each element of the electrode array comprises an electrode and an electrode interconnect extending through the array insulator and electrically interconnecting the electrode with one electrode connector of the array of electrode connectors,
the electrode interconnect comprises a bottom interlayer conductor, a bottom metal trace, a second interlayer conductor, a second metal trace, and a top insulator sublayer,
the bottom interlayer conductor is located at least partially within one via of bottom-insulator-sublayer vias extending through the bottom insulator sublayer,
the second interlayer conductor is located at least partially within one via of second-insulator-sublayer vias extending through the second insulator sublayer,
the second interlayer conductor is offset relative to the bottom interlayer conductor, does not overlap with the bottom interlayer conductor, and is connected to the bottom interlayer conductor by the bottom metal trace,
the top interlayer conductor is located at least partially within one via of top-insulator-sublayer vias extending through the top insulator sublayer,
the top interlayer conductor is offset relative to the second interlayer conductor, does not overlap with the second interlayer conductor, and is connected to the second interlayer conductor by the second metal trace,
the array insulator comprises an insulator surface facing away from the electrode interface circuit and at least partially defined by an insulator surface plane, and the electrode at least partially extends over the insulator surface.

2. The printhead of claim 1, wherein:
the bottom metal trace, interconnecting and extending between the bottom interlayer conductor and the second interlayer conductor, defines a bottom-metal-trace path, and
an overall path length of the bottom-metal-trace path is greater than a direct distance required to directly connect the bottom interlayer conductor and the second interlayer conductor.

3. The printhead of claim 2, wherein the overall length of the bottom-metal-trace path is at least 3 times greater than the direct distance between the bottom interlayer conductor and the second interlayer conductor.

4. The printhead of claim 1, wherein the bottom metal trace has a serpentine shape.

5. The printhead of claim 1, wherein the bottom metal trace has a spiral shape.

6. The printhead of claim 1, wherein the top interlayer conductor is operable as the electrode.

7. The printhead of claim 1, wherein the bottom interlayer conductor directly interfaces and is connected to the electrode connectors of an electrode-interface circuit.

8. The printhead of claim 1, wherein:
the second metal trace, interconnecting and extending between the second interlayer conductor and the top interlayer conductor, defines a second-metal-trace path, and
an overall path length of the second-metal-trace path is greater than a second direct distance required to directly connect the second interlayer conductor and the electrode.

9. The printhead of claim 1, further comprises an adhesion layer disposed at least partially between the electrode and the insulator surface.

10. The printhead of claim 9, wherein the adhesion layer comprises at least one of silicon nitride (SiNx) and silicon oxide (SiO2).

11. The printhead of claim 1, wherein:
the array insulator comprises an insulator surface facing away from the electrode interface circuit and at least partially defined by an insulator surface plane,
the array insulator comprises an insulator via and an insulator recess protruding away from the insulator surface plane and toward, but not extending to, the electrode interface circuit, and
a first portion of the electrode protrudes into the insulator via and makes a connection with the electrode interconnect.

12. The printhead of claim 11, wherein a second portion of the electrode extends away from the insulator via and comprises an electrode edge at least partially within the insulator recess.

13. The printhead of claim 12, wherein a length of an interface between the insulator surface and the second portion of the electrode is at least 10% greater than a projection of this length to the insulator surface plane.

14. The printhead of claim 12, wherein a length of an interface between the insulator surface and the second portion of the electrode is at least 30% greater than a projection of this length to the insulator surface plane.

15. The printhead of claim 12, wherein the insulator via and the insulator recess are separated by a portion of the array insulator extending to the insulator surface plane.

16. The printhead of claim 12, wherein the first portion of the electrode has an exposed edge positioned below the insulator surface plane.

17. The printhead of claim 12, further comprising a metal edge protective layer extending over at least a portion of the array insulator and at least a portion of the electrode such that at least a portion of the electrode edge is covered with the metal edge protective layer.

18. The printhead of claim 17, wherein the metal edge protective layer is formed from an electronically insulating material.

19. The printhead of claim 18, wherein the metal edge protective layer extends between and overlaps with both the electrode and an adjacent electrode.

20. The printhead of claim 17, wherein the metal edge protective layer is formed from one or more materials selected from the group consisting of a polyimide (PI), a polybenzoxazole (PBO), a patternable epoxy, and a metal oxide.
